(19) United States
(12) Patent Application Publication
(10) Pub. No.: US 2008/0318636 A1
(43) Pub. Date: Dec. 25, 2008

(54) MOBILE COMMUNICATION TERMINAL WITH IMPROVED INTERFACE FUNCTION AND METHOD FOR IMPROVING INTERFACE FUNCTION

(75) Inventor: In-Gyu KIM, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 12/203,404

(22) Filed: Sep. 3, 2008

(30) Foreign Application Priority Data
Mar. 9, 2007 (KR) 2007-0089119

(51) Int. Cl. H04M 1/00

(52) U.S. Cl. 455/566

(57) ABSTRACT

Disclosed is method for improving an interface function in a wristwatch-type mobile communication terminal, including an arrangement of placing sub-display units on opposite watch band portions with reference to a main display unit. A captured image of a content displayed on the main display unit is adapted to be displayed on a desired sub-display unit. As such, the user can refer to the content displayed on the sub-display units, while implementing a desired function through the main display unit. In addition, the sub-display unit can be used as an additional key-inputting means, so that key-inputting can be easily performed.

### PRIORITY

This application claims priority under 35 U.S.C. §119(a) to a Korean application filed in the Korean Intellectual Property Office on Sep. 3, 2007 and assigned Serial No. 2007-89119, the contents of which are hereby incorporated by reference.

### BACKGROUND OF THE INVENTION

1. Field of the Invention

The present invention relates to a wristwatch-type mobile communication terminal, and in particular to a wristwatch-type mobile communication terminal with an improved interface function and a method for improving such an interface function.

2. Description of the Related Art

When designing a portable mobile communication terminal, considerations are made to functionality, convenience, size, design, etc. Recently, the design for mobile terminals that are convenient for carrying and reduced in size has been focusing on miniaturizing circuit devices or parts for use in the mobile communication terminals and simplifying the circuits thereof. As a result, the mobile communication terminals are substantially miniaturized as compared to early mobile communication terminals, and users are able to carry mobile communication terminals more conveniently.

Such mobile communication terminals involve wristwatch-type mobile communication terminals configured as a watch type to be capable of being worn on a wrist. In such a wristwatch-type mobile communication terminal, it is necessary to miniaturize a main body, so that the communication terminal can be easily worn on a wrist. However, a display unit for displaying an operation condition and a content, function keys for manipulating functions, and dialing keys are essentially provided on the main body. Therefore, each of such components are required to have a size larger than a predetermined size so as to display a screen or key-inputting, which constitutes a restriction on designing such mobile communication terminals.

As described above, because a conventional wristwatch-type mobile communication terminal should accommodate a predetermined size of screen in a main body thereof, there is a limitation in increasing the size of the screen. In addition, it is difficult to efficiently show the various functions of the mobile communication terminal through such a small screen. Moreover, an ordinary watch band is employed so as to wear the wristwatch-type mobile communication terminal on a wrist. In a mobile communication terminal miniaturized to such an extent, there is a limitation in providing a data input/output device or the like. Therefore, there is a need to provide a construction allowing an interface function to be improved, thereby avoiding the limitation in miniaturizing and designing such a wristwatch-type mobile communication terminal.

### SUMMARY OF THE INVENTION

Accordingly, the present invention has been made to solve the above-mentioned problems occurring in the prior art, and the present invention provides a wristwatch-type mobile communication terminal with an improved interface function, and a method for improving such an interface function while overcoming the restriction in designing a wristwatch-type mobile communication terminal.

According to an aspect of the present invention, there is provided a mobile communication terminal with an improved interface function including a main body, on which a main display unit is mounted; at least two sub-bodies positioned at opposite ends of the main body, respectively, each of the sub-bodies being provided with a sub-display unit; connection means for interconnecting the main body and one side of each of the sub-bodies; and a band connected to the other side of each of the sub-bodies, the band fixing the mobile communication terminal to a user's wrist.

According to another aspect of the present invention, there is provided a mobile communication terminal with an improved interface function, including a main display unit implemented as a touch screen, the main screen being adapted to output a signal according to a user's touch-inputting; a sub-display unit mounted adjacent to one side of the main display unit; and a control unit for controlling the mobile communication terminal in such a manner that when a drag-and-drop signal is transmitted from the main display unit, an image displayed on the main display unit is captured, and the captured image is displayed on the sub-display unit.

According to another aspect of the present invention, there is provided a method for improving an interface function in a mobile communication terminal with a main display unit and a sub-display unit, including determining whether a drag-and-drop occurs according to a user's touch-inputting through the main display unit implemented as a touch screen; capturing an image displayed on the main display unit when it is determined that the drag-and-drop occurs; and displaying the captured image on the sub-display unit.

### BRIEF DESCRIPTION OF THE DRAWINGS

The above and other objects, features and advantages of the present invention will be more apparent from the following detailed description taken in conjunction with the accompanying drawings, in which:

FIG. 1 is a schematic view for exemplifying a wristwatch-type mobile communication terminal according to an embodiment of the present invention;

FIG. 2 is a block diagram showing an inner construction of a wristwatch-type mobile communication terminal according to an embodiment of the present invention;

FIG. 3 is a flowchart for a method of providing a capture function in a wristwatch-type mobile communication terminal according to an embodiment of the present invention;

FIG. 4 is a schematic view exemplifying a screen for describing FIG. 3;

FIG. 5 is a flowchart for a method of providing a character input unction according to another embodiment of the present invention;

FIG. 6 is a schematic view exemplifying a screen for describing FIG. 5; and

FIG. 7 is a schematic view exemplifying a screen for outputting various color stripes.

### DETAILED DESCRIPTION OF THE PREFERRED EMBODIMENTS

Hereinafter, preferred embodiments of the present invention will be described with reference to the accompanying drawings. In the following description of the present invention, a detailed description of known functions and configurations incorporated herein will be omitted when it may make the subject matter of the present invention rather unclear.

The present invention provides a measure for improving an interface function in a wristwatch-type mobile communication terminal. For this purpose, the present invention provides an additional arrangement of sub-display units on opposite watch band portions with reference to a main display unit. A preferred embodiment of the present invention renders a captured image of a displayed content on the main display unit to be displayed on a desired sub-display unit. By doing so, a user can refer to the content displayed on the corresponding sub-display unit while rendering a desired function implemented on the main display unit. In addition, another preferred embodiment of the present invention uses the sub-display units as additional key-inputting means, thereby allowing a key-inputting to be easily performed.

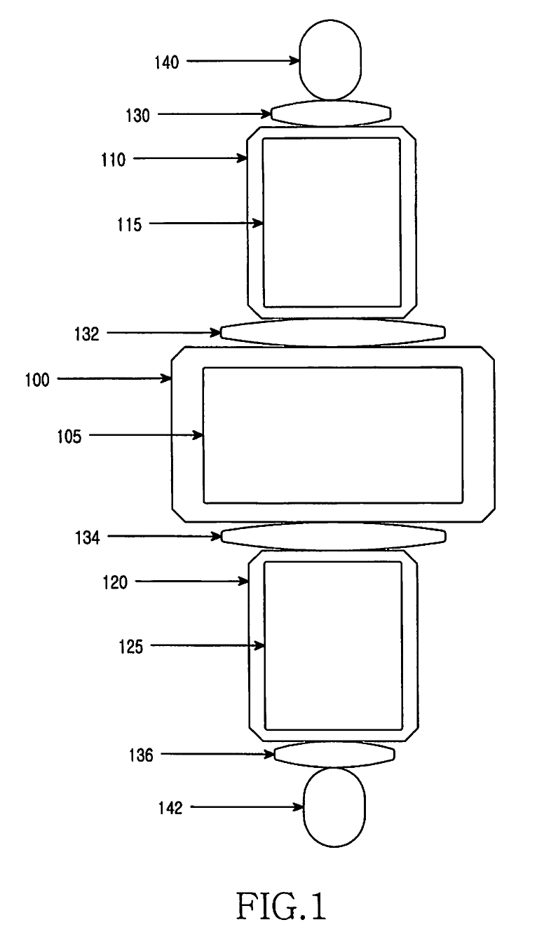

A wristwatch-type mobile communication terminal provided with the above-mentioned functions will be described with reference to FIG. 1. FIG. 1 is a schematic view showing a wristwatch-type mobile communication terminal according to a preferred embodiment of the present invention. Although the present invention will be described in terms of a wristwatch-type mobile communication by way of an example, a single main display unit and two or more sub-display units can be applied to all kinds of mobile communication terminals.

Referring to FIG. 1, the wristwatch-type mobile communication terminal includes a main body 100 equipped with a main display unit 105, a first sub-body provided with a first sub-display unit 115, a second sub-body provided with a second sub-display unit 125, hinges 132 and 134 for connecting the first and second sub-bodies 110 and 120 to the main body 100, respectively, watch bands 140 and 142 connected to the first and the second sub-bodies 110 and 120 at the sides of the first and the second sub-bodies 110 and 120 opposite to the hinges 132 and 134, respectively, so as to fix the wristwatch-type mobile communication terminal on a wrist, and hinges 130 and 136 for connecting the first and the second sub-bodies 110 and 120 with the watch bands 140 and 142, respectively.

Specifically, the main display unit 105 is mounted on the main body 100, wherein the main display unit 105 may be a touch screen. The first and the second sub-bodies 110 and 120 are oppositely positioned with reference to the main body 100. The first and the second sub-display units 115 and 125 mounted on the first and the second sub-bodies 110 and 120, respectively, serve to display auxiliary data.

The hinges 130, 132, 134 and 136 are connecting means for interconnecting respective components. Herein, the term hinge is used for describing connecting means. Preferably, the connecting means between the main body 100 and the first and second sub-bodies 110 and 120 are flexible or curved, so that they can be worn on a user's wrist. However, such a connecting means is not limited to a hinge. Likewise, the watch bands 140 and 142 are connected to one side of each of the first and the second sub-bodies 110 and 120, respectively. The watch band 140 connected to the first sub-body 110 has a shape to be engaged with the watch band 142 connected to the second sub-body 120. At this time, the wristwatch-type mobile communication terminal may be additionally provided with connecting means 130 and 136, such as hinges between the flexible watch bands 140 and 142 to be wounded around the user's wrist.

In addition, each of the watch bands 140 and 142 is a component like an ordinary band. FIG. 1 shows the watch bands 140 as if their lengths are shorter than those of the sub-bodies 110 and 120. However, this is merely an exemplification, and the material and lengths of the watch bands 140 and 142 may be changed. That is, the watch bands 140 and 142 may be formed from any material allowing them to be wound around a wrist in a predetermined length.

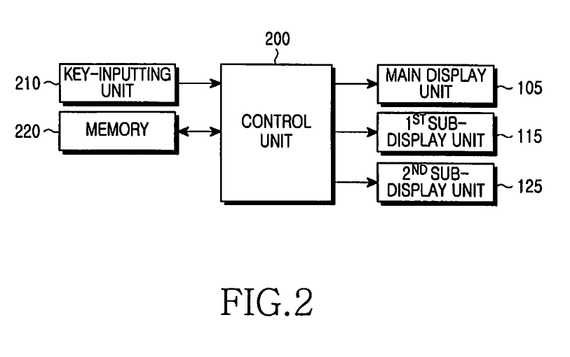

Now, the components and internal operation of the wristwatch-type mobile communication terminal according to a preferred embodiment of the present invention will be described with reference to FIG. 2. FIG. 2 is a block diagram showing internal components of the wristwatch-type mobile communication terminal according to the present embodiment.

Referring to FIG. 2, a control unit 200 performs a general control operation for the wristwatch-type mobile communication terminal. In particular, according to the embodiment of the present invention, when a capture function is selected by the user, the control unit 200 controls the communication terminal in such a manner that the content displayed on the main display unit 105 is captured and displayed on a sub-display unit. At this time, the user can designate the sub-display unit to display the captured image.

In addition, according to another embodiment of the present invention, the control unit 200 controls the communication terminal in such a manner that a key region is displayed on a sub-display unit so that character input can be easily performed, and inputted data is displayed on another display unit when there is data inputted through the key region. Here, the other display unit may be the main display unit 105 or the remaining sub-display unit.

A key-inputting unit 210 is connected to the control unit 200, wherein the key-inputting unit 210 consists of a plurality of numeric and character keys. The key-inputting unit 210 serves to transmit inputted data corresponding to one or more keys selected by the user. Such a key-inputting unit 210 may be configured with minimal function keys if the main display unit 105 and/or the sub-display units 115 and 125 are implemented as touch screens.

A memory 220 may be configured by a Read Only Memory (ROM), a Random Access Memory (RAM), etc. for storing a plurality of programs and data. In particular, according to another preferred embodiment of the present invention, the memory 220 stores character groups by character regions displayed in the character mode. Here, the term character group means a predetermined number of characters configured by consonants and vowels of Hangul (the Korean alphabet), capital letters and small letters of English alphabet, numeral letters, and special characters (hereinbelow, “characters”), and the character groups are divided depending on the total number of the character regions.

The main display unit 105 may be configured by a Liquid Crystal Display (LCD), and displays various data transmitted by the control unit 200. If the main display unit 105 is implemented as a touch screen, a plurality of character keys, numeric keys, function keys, direction keys, and other keys, including data displayed on the touch screen, can be selected or inputted by an input instrument, such as a stylus pen or the user's fingers.

Meanwhile, according to the present invention, a wristwatch-type mobile communication terminal is additionally provided with a sub-display unit for allowing an interface function to be improved while overcoming restrictions of design in mounting the data input/output device.

The first and the second sub-display units 115 and 125 are mounted adjacent to the main display unit 105. For example, if the first sub-display unit 115 is mounted adjacent to one side of the main display unit 105, then the second sub-display unit 125 is mounted adjacent to the other side of the main display unit 105. Like the main display unit 105, each of the sub-display units 115 and 125 may be configured by an LCD or the like, and when the main display unit 105 is used for inputting data, each of the sub-display units 115 and 125 may serve as a display window. In addition, when the main display unit 105 is used for inputting data, each of the sub-display units 115 and 125 may be used as an additional input means so as to allow the user to input data more easily. For example, data inputting through the first and the second sub-display units 115 and 125 is enabled if the first and the second sub-display units 115 and 125 are configured as touch screens. In addition, the first and the second sub-display units 115 and 125 may be used for displaying various data like the data displayed on the main display unit 105.

The first and the second sub-display units 115 and 125 may be used as data outputting means, thereby may be used for displaying an image transferred from the main display unit 105. For example, like the case where an image displayed on a main monitor is transferred to and displayed on a sub-monitor in a dual LCD monitor, an image displayed on the main display unit 105 is transferred to and displayed on a sub-display unit. The present embodiment captures an image displayed on the main display unit and transfers the captured image to the first sub-display unit 115 or the second sub-display unit 125, so that the captured image is displayed on the first sub-display unit 115 or the second sub-display unit 125, rather than merely being transferred to a display window from the main display unit 105.

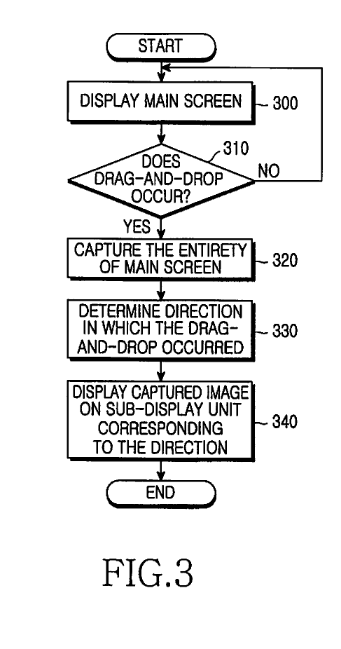

Now, the operation in the above-mentioned wristwatch-type mobile communication terminal will be described with reference to FIG. 3. FIG. 3 is a flowchart for a capture function in a wristwatch-type mobile communication terminal according to a preferred embodiment of the present invention.

Referring to FIG. 3, the control unit 200 renders a main screen displayed on the main display unit 105 in step 300. Next, the control unit 200 determines whether a drag-and-drop operation is made on the main screen by a user. The drag-and-drop is an event occurring according to the user's touch input through the main display unit 105 implemented as a touch screen. If a signal according to the production of the drag-and-drop is transmitted through the main display unit 105, the control unit 320 proceeds to step 320 so as to capture the entirety of the main screen. In that event, the captured image may be temporarily stored in a virtual memory, and the drag-and-drop event corresponds to a command for screen-capturing. Thereafter, the control unit 200 determines in which direction the drag-and-drop occurred. As such, in step 340, when a drag-and-drop occurs, the control unit 200 renders the captured image displayed on a sub-display unit in the corresponding direction, i.e. in the direction in which the drag-and-drop has occurred.

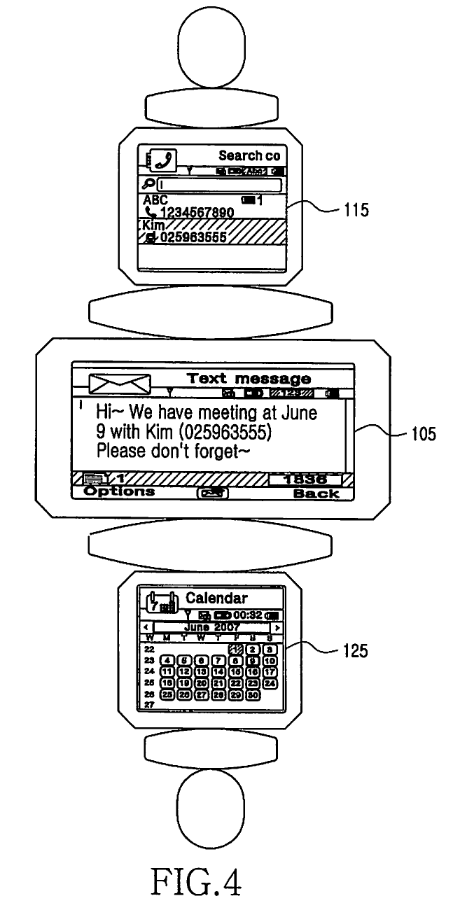

FIG. 4 illustrates a case in which a character input window according to a character input mode is displayed on the main display unit 105, a telephone number search screen is displayed on the first sub-display unit 115, and a schedule screen is displayed on the second sub-display unit 125. According to a preferred embodiment of the present invention, images captured according to the drag-and-drop events may be displayed as shown in FIG. 4.

If a user presses a finger and drags downward on the schedule screen displayed on the main display unit 105 while viewing the schedule screen, the schedule screen is captured. The schedule screen image captured in this manner is displayed on the second sub-display unit 125 as shown in FIG. 4, wherein the schedule image may be reduced in size as compared to its size displayed on the main display unit 105 in consideration of the size of the second sub-display unit 125. In addition, if the user presses a finger and drags upward on the telephone number search screen displayed on the main display screen 105 while viewing the telephone number screen, the telephone number search screen is captured. The telephone number search screen image captured in this manner is displayed on the first sub-display unit 115 corresponding to the drag direction, as shown in FIG. 4. In addition, the respective contents displayed on the sub-display units 115 and 125 may be deleted when the communication terminal is switched to a stand-by mode.

If the user prepares a text message through the character input window on the main display unit 105 as shown in FIG. 4, the user can prepare the character message with reference to the contents displayed on each of the sub-display units 115 and 125. As such, the user retains desired contents displayed on one or more sub-display units without obscuring the main screen when inputting data through the main display unit, whereby the user can conveniently see the contents on the main display unit and the sub-display units. In addition, according to the present invention, the screen of the wristwatch-type mobile communication terminal is not limited to the main body of the watch, whereby it is possible to extend the size of the screen.

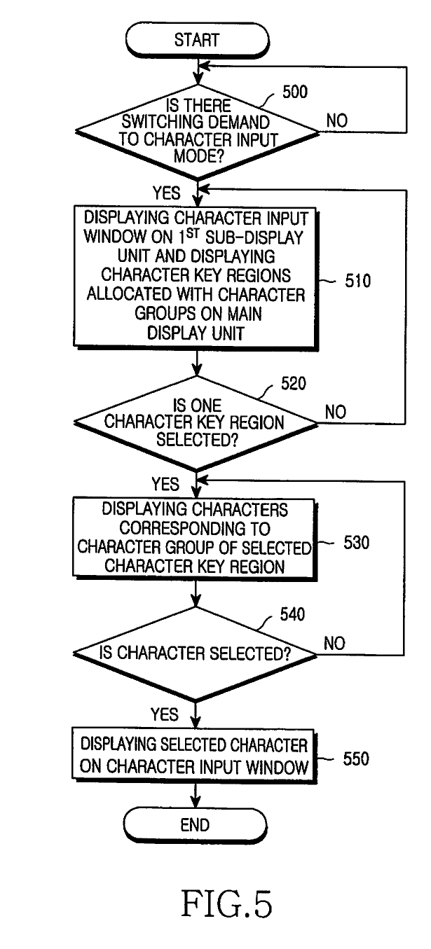

Now, a method of providing a character input function according to another preferred embodiment of the present invention will be described with reference to FIG. 5. Referring to FIG. 5, the control unit determines whether there is a demand by a user to switch the communication terminal to the character input mode in step 500. If it is determined that the mode-switching demand by the user is inputted, the control unit 200 displays the character input window on any one of the sub-display units in step 510, and displays character key regions, to which character groups are allocated, on the main display unit 105.

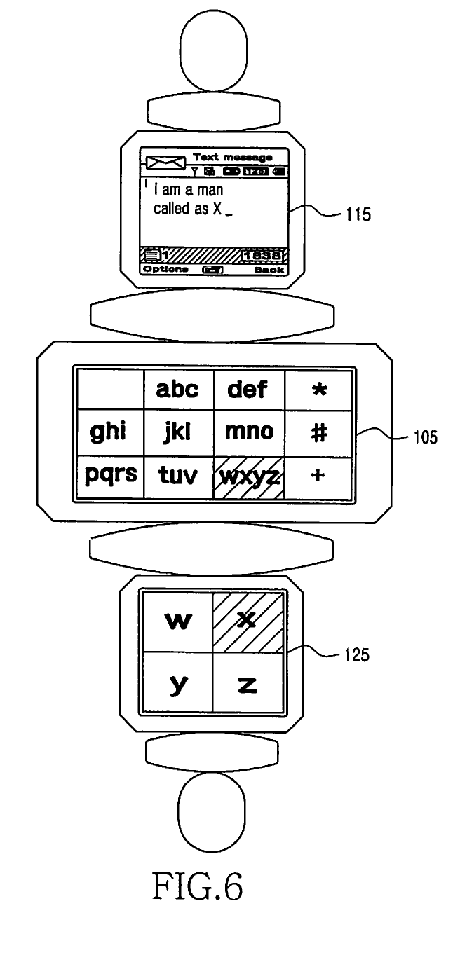

FIG. 6 shows respective screens related to the character input mode according to the other preferred embodiment of the present invention. Although the method of providing a character input function is exemplified in FIG. 6, the present invention is not limited thereto.

FIG. 6 shows a case in which the character key regions, to which the character groups are allocated, are displayed on the main display unit 105 when the first sub-display unit 115 is used for displaying the character input window. From this state, the control unit 200 determines whether any one of the character key regions displayed on the main display unit 105 is selected in step 520. If it is determined that one of the character key regions is selected, the control unit 200 displays the characters corresponding to the character group of the selected character key region on the other sub-display unit in step 530. Then, in step 540, the control unit 200 determines whether any one character among the characters corresponding to the character group is selected, and if one character is selected, the control unit 200 displays the selected character on the character input window.

Of course, if only one sub-display unit is provided, the character input window may be displayed on the sub-display unit, and the character key regions may be displayed on the main display unit 105. At this time, the user may select the characters in the character key regions according to the number of times of touch-inputting on the main display unit 105.

In FIG. 6, the character input window is displayed on the first sub-display unit 115, the character key regions are displayed on the main display unit 105, and the characters corresponding to the character group of the selected character key region are displayed on the second sub-display unit 125. In particular, in FIG. 6, when any one of the character key regions is selected, each of the characters corresponding to the character group of the selected character key region is allocated to one character region, respectively, on the remaining sub-display unit, i.e. the second sub-display unit 125. As such, if each of the characters are allocated to one character region and displayed on the second sub-display unit 125, the user can select and input desired characters more easily as compared to the case in which the user selects characters among the character key regions displayed on the main display unit 105.

Although FIG. 6 shows a case in which the character window is displayed on one sub-display unit, and the respective character key regions and characters are displayed on the other sub-display unit, the character input function can be set in such a manner that each of the sub-display units is used for inputting characters, and the main display unit is used for outputting characters.

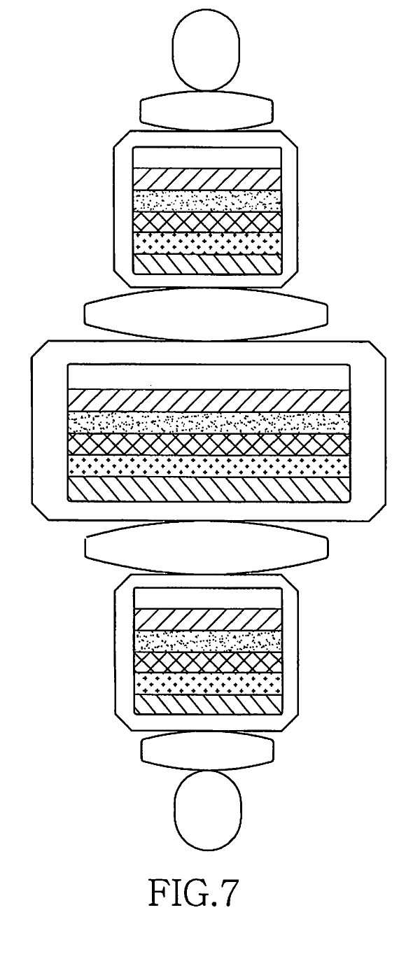

According to another embodiment of the present invention, the three display units can be used for notifying a user of call incoming at the time when a call is received. For example, the communication terminal can be set in such a manner that each of the display units flickers, or the display units are sequentially turned on. In addition, the communication terminal may be set in such a manner that, in a sleep mode, various color stripes are output through the respective display units, as shown in FIG. 7. As such, it is possible to avoid a construction affording a restriction in miniaturizing and designing a wristwatch-type mobile communication terminal, and to satisfy various tastes of users.

According to the present invention, it is possible to extend a user's interface function by extending a display unit to a watch band. In addition, by providing a capture function, it is possible to provide various input methods, for example, a method of providing two reference screens, a method of inputting through one or more extended sub-display unit, etc. Furthermore, by arranging sub-display units on the opposite sides of a main display unit, an ornamental armband effect can be expected through the main display unit and the sub-display units, and the design of the wristwatch-type mobile communication terminal can be enhanced.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A mobile communication terminal with an improved interface function, comprising:
a main display unit implemented as a touch screen, the main display unit being adapted to output a signal according to a user's touch-input;
a sub-display unit mounted adjacent to one side of the main display unit; and
a control unit for controlling the mobile communication terminal in such a manner that, when a drag-and-drop signal is transmitted from the main display unit, an image displayed on the main display unit is captured, and the captured image is displayed on the sub-display unit.

2. The mobile communication terminal as claimed in claim 1, further comprising a sub-display unit mounted adjacent to the other side of the main display unit.

3. The mobile communication terminal as claimed in claim 2, wherein each of the sub-display units is implemented as a touch screen.

4. The mobile communication terminal as claimed in claim 2, wherein, when the drag-and-drop signal is transmitted, the control unit determines in which direction the drag-and-drop occurred, and displays the captured image on the sub-display unit corresponding to the direction in which the drag-and-drop occurred.

5. The mobile communication terminal as claimed in claim 3, wherein, when a demand of switching to a character input mode is input by the user, the control unit displays a character input window on one of the sub-display units, and displays character key regions, to which character groups are allocated, on the main display unit.

6. The mobile communication terminal as claimed in claim 5, wherein, when one of the character key regions displayed on the main display unit is selected, the control unit displays characters corresponding to the character group of the selected character key region on the other sub-display unit, and if one character is selected, the control unit outputs the selected character on the character input window.

7. A method for improving an interface function in a mobile communication terminal with a main display unit and a sub-display unit, comprising:
determining whether a drag-and-drop operation occurs according to a user's touch-inputting through the main display unit implemented as a touch screen;
capturing an image displayed on the main display unit when it is determined that the drag-and-drop operation occurs; and
displaying the captured image on the sub-display unit.

8. The method as claimed in claim 7, further comprising:
determining in which direction the drag-and-drop operation occurred when two or more sub-display units are provided; and
displaying the captured image on the sub-display unit corresponding to the direction to which the drag-and-drop operation occurred.

9. The method as claimed in claim 7, wherein at least two sub-display units are provided, each of the sub-display units being implemented as a touch screen.

10. The method as claimed in claim 9, further comprising:
determining whether there is a switching demand to a character input mode input by a user;
displaying a character input window on one of the sub-display unit, and character key regions, to which the character groups are allocated, on the main display unit when the switching demand is input;
determining one of the character key regions is displayed on the main display unit;
displaying characters corresponding to the character group of one character key region on the other sub-display unit if it is determined that the one character key region is selected; and
outputting a character on the character input window if the character is selected among the displayed characters.
